(19) United States
(12) Patent Application Publication
(10) Pub. No.: US 2012/0165565 A1
(43) Pub. Date: Jun. 28, 2012

(54) SYNTHESIS OF FLUOROCARBOFUNCTIONAL ALKOXYSILANES AND CHLOROSILANES

(75) Inventors: Bogdan Marciniec, Swarzedz (PL); Hieronim Maciejewski, Poznan (PL); Michal Dutkiewicz, Poznan (PL); Izabela Dabek, Poznan (PL); Joanna Karasiewicz, Komorniki (PL)

(73) Assignee: ADAM MICKIEWICZ UNIVERSITY, Poznan (PL)

(21) Appl. No.: 13/393,371

(22) PCT Filed: Aug. 16, 2010
(86) PCT No.: PCT/PL2010/000072

§ 371 Date: Feb. 29, 2012

(30) Foreign Application Priority Data
Sep. 1, 2009 (PL) P.388929
Sep. 1, 2009 (PL) P.388930

(51) Int. Cl. C07F 7/18; C07F 7/12

(52) U.S. Cl. 556/448

(57) ABSTRACT

The subject of invention is the method of synthesis of fluorocarbofunctional alkoxysilanes and chlorosilanes of the general formula HCF₂(CF₂)ₙ(CH₂)ₘOC₃H₇SiR¹R²R³ in which -n takes values from 1 to 12, m takes values from 1 to 4,—R¹ stands for an alkoxy group or halogen, if R¹ stands for an alkoxy group, then R² and R³ can be the same or different and stand for an alkoxy group containing C=1-4, alkyl group containing C=1-12 or an aryl group, if R¹ stands for a halogen, then R² and R³ can be the same or different and stand for based on hydrosilylation of an appropriate fluoroalkyl-allyl ether with an appropriate trisubstituted silane of the general formula HSiR¹R²R³ in the presence of siloxide rhodium complex [{Rh(OSiMe₃)(cod)}₂] as a catalyst.

The subject of invention is the synthesis of fluorocarbofunctional silanes of the general formula 1,

HCF₂(CF₂)ₙ(CH₂)ₘOC₃H₇SiR¹R²R³ (1)

in which:
n takes values from 1 to 12, m takes values from 1 to 4,
R¹ stands for an alkoxy group or halogen,

R² and R³ can be the same as R¹ or different from it and stand for:

if R¹ stands for an alkoxy group, then R² and R³ can be the same or different and stand for an alkoxy group containing C=1-4, alkyl group containing C=1-12 or an aryl group,

if R¹ stands for a halogen, then R² and R³ can be the same or different and stand for a halogen, alkyl group containing C=1-12 or an aryl group,

Organosilicon derivatives containing fluorine are of interest mainly because of their application in production of modern materials. Fluoroalkyl silanes are used as surfactants, for surface modification of lenses and optical fibres, for production of oil-, dirt- and water-repellent surfaces, as lubricants, as components of many cosmetic preparations and as modifiers of fluorine and silicon rubber. In spite of many interesting properties, fluoroalkyl silanes are not commonly applied mainly because of problems in their synthesis, high price and poor accessibility of raw products. Fluorocarbofunctional alkyl-, alkoxy- or arylsilanes containing at least one alkoxy group are obtained by alcoholysis of appropriate fluorocarbofunctional chlorosilanes.

Direct hydrosilylation of fluorocarbofunctional silanes gives exclusively fluorocarbofunctional chloroalkylsilanes which upon alcoholysis are transformed into the corresponding derivatives containing alkoxy groups. Hence the process must be conducted in two steps of addition and alcoholysis. Moreover, the product of alcoholysis is acidified because of liberation of HCl in the process and must be deacidified as otherwise the product is unstable and undergoes condensation.

The most popular method of synthesis of fluorocarbofunctional chloroalkylsilanes is hydrosilylation of the appropriate fluorinated olefins. Because of the electropositive character of silicon, the unsaturated group of the olefin used cannot be fluorinated and should necessary be a vinyl group —CH═CH2 or allyl group —CH2CH═CH2. The presence of the latter is particularly beneficial because of its reactivity.

On the industrial scale fluorinated olefins are obtained from fluoroalkyl iodide as a precursor, which means that the olefin obtained can contain certain amounts of iodide ions that have adverse effect on hydrosilylation as they poison the catalyst. In the majority of methods of synthesis the catalyst is dissolved in the olefin and silane is introduced to this mixture, so if the iodide ions present in the olefin lead to the catalyst poisoning, the reaction will not take place and the mixture of expensive raw products is unsuitable for further use.

Hydrosilylation is the main reaction used in synthesis of fluorinated silanes (1).

The catalysts of hydrosilylation of fluorolefines are platinum species; WO 2006/127664 patent describes the use of hexachloroplatinic acid H₂PtCl₆ with platinum at the fourth state of oxidation as a catalyst, while EP 0075865 patent describes the use of compound with platinum at the second state of oxidation [PtCl₂(cod)] and U.S. Pat. No. 6,255,516 describes the use of Karstedt's catalyst with platinum at the zero state of oxidation. Platinum compounds show catalytic activity in hydrosilylation of a wide group of different functional olefins, but they are susceptible to poisoning by different impurities, in particular iodide ions (2).

There are known methods of synthesis of fluorocarbofunctional silanes by hydrosilylation in a closed system. The Japanese patent JP 02178292 describes the reaction of fluorolefin with HSiCl₃ in a sealed glass pipe in the presence of H₂PtCl₆, at 100° C. and taking place for 3 h with the yield of 86%. The European patent EP 0538061 discloses the reaction of fluoroolefin with HSiMeCl₂ over H₂PtCl₆ as a catalyst, taking place in an autoclave at 120° C., for 20 h with the yield of 67%. From the technological point of view such reactions are very difficult because of the need to apply high pressure, low boiling points of the reagents and hence high vapour pressure and aggressive properties of the reagents implying the need to use the pressure apparatus made of special expensive materials.

Hydrosilylation reactions conducted under atmospheric pressure need much prolonged time of the process. JP 06239872 patent describes the high pressure process performed for 48 h, at 150° C. with the yield of 88%, while WO94/20442 patent presents the process run at 100° C. for 50 h with the yield of 89%. Long time of the reaction and high temperature needed have negative effect on the selectivity of the process as such conditions favour isomerization of olefins and shifting of the double bond from the terminal to inner position. Addition of silane to the double bond does not take place at the position other than terminal, which means that a lot of side products are formed and that the yield decreases.

Hydrosilylation is an exothermic process, which means that after initiation of the reaction and in particular in the presence of highly active platinum catalysts, the temperature of the process rapidly increases that can lead to isomerization of fluorinated olefins, so to decrease in the yield and selectivity. To protect against the rapid increase in temperature, according to GB2443626 patent, different solvents are used: e.g. toluene, isooctane, hexane, trifluoromethylbenzene, 1,3-bis(trifluoromethyl)benzene, in the amount of 10-90%. The use of solvents prevents from rapid and hard to control temperature increase, but on the other hand, it implies the need of additional stage of the solvent removal, most often by energy and time consuming distillation.

The sequence of substrate addition often influences the course of hydrosilylation of fluorinated olefins. Usually, HSiMeₙCl₃₋ₙ silane is introduced dropwise to a mixture of the fluorinated olefin and catalyst that has been heated to a certain desired temperature. The U.S. Pat. No. 5,869,728 and U.S. Pat. No. 6,255,516 propose dropwise introduction of fluorinated olefin into a mixture of silane and catalyst, which reduces the risk of the catalyst poisoning with iodide ions present in the fluorinated olefin and permits interruption of the process in the beginning stage thus limiting the loss of expensive olefins. However, mixing silane with catalyst can also lead to many undesired side processes, like e.g. redistribution of silanes, which drastically decreases the yield of the main process.

In the second group of methods of fluorocarbofunctional silanes synthesis the substrates are fluoroalkyl-allyl ethers and perfluorinated allyl polyethers.

The European patent EP0075864 describes the synthesis of (tetrafluoro-ethyloxypropyl)methylchlorosilanes by hydrosilylation of allyl-tetrafluoro-ethyl ether with trichlorosilane and methyldichlorosilane. The process is conducted in a pipe reactor under a pressure of 5 bars at 100° C. in the presence of [{PtCl₂(octene)}₂] as a catalyst. The main product obtained with the yield of 78-90% is accompanied by many products of redistribution of the initial silane and fluoroalkyl-allyl ether. The patent also describes an analogous reaction performed under atmospheric pressure over the same catalyst. In these conditions the main product was obtained with the yield of 46%. To obtain satisfactory yield the reaction needs to be carried out under high pressures, moreover, the product contains many impurities.

The patent EP0075865 describes the method of synthesis of (hexafluoropropyloxypropyl)methylchlorosilanes by hydrosilylation of allyl-hexafluoropropyl ether with trichloro- and methyldichlorosilanes (analogous as in EP0075864). By alcoholysis of the main products (hexafluoropropyloxy-propyl)trialkoxy- and (hexafluoropropyloxypropyl)-methyldialkoxy-silanes were obtained.

The patent WO 2006/127664 reports a complex multistage process of synthesis of a numerous group of perfluoropolyether derivatives of silicon with the use of different linear and branched fluorinated polyethers of the formula

HOCH₂[(CF₂)ₚO(CFR¹)_{q}]ₘ[(CF₂)ₙO]ₘ[(CFR¹)_{q}O(CF₂)ₚ]ₘR¹,

where R¹ can be CF₃, C₂F₅, CF(CF₃)₂ or other similar groups. The derivatives of this type at the first stage are subjected to the reaction with sodium hydride and transformed into the corresponding sodium alcoholates, which subsequently in the reaction with allyl bromide are transformed into polyethers containing an allyl group. These derivatives are subsequently subjected to hydrosilylation with trichlorosilane. This process is conducted in a high pressure reactor at a temperature from the range 165-175° C. range for 8 hours. After the reaction, the crude product is purified by ditillation and the yield of the process is 95%. At the next stage, the trichlorosilyl derivative is subjected to alcoholysis by methanol leading to the appropriate trialkoxysilyl derivative of perfluorinated polyethers.

The U.S. Pat. No. 5,869,728 and U.S. Pat. No. 6,255,516 disclose the synthesis based on hydrosilylation of tetrafluoroethyl-allyl ether with trichlorosilane over a Karstedt catalyst (Pt(0) in divinyltetramethyldisiloxane) at 110° C. for 3 hours. After completion of the process the product is purified by thin film distillation and then in a separate reaction set the product is subjected to the reaction with sodium ethanolate leading to alkoxy derivative that needs additional purification by distillation. The multistage character of the process is undesirable because of increased consumption of energy, extended duration of the whole process and the amount of waste products.

Another method is given in the patent WO2005058919 describing the synthesis of fluorocarbofunctional chloroalkylsilanes by hydrosilylation of fluoroalkyl-allyl ether. In this method ether is introduced into a solution of the catalyst in trichlorosilane placed in the autoclave. The reaction is performed under elevated pressure of 5-6 bar at a temperature from the range 100-130° C. and with the yield of 82%.

The methods of synthesis of fluoroalkylalkoxy chlorosilanes described in the above patents need high pressure and high temperature, so from the technological point of view they are difficult, requiring special apparatuses, high pressure reactors and special safety precautions following from the need of high pressure application.

Chlorosilyl and methyldichlorosilyl fluorocarbofunctional silanes are susceptible to hydrolysis in the presence of trace amounts of moisture, so the process of alcoholysis must be conducted in absolutely anhydrous environment, which poses additional difficulty and implies the need to use fully dried substrates, protect the reaction system against moisture and use the apparatuses made of materials resistant to corrosion.

The subject of invention is a cheap and effective method of synthesis of fluorocarbofunctional alkoxysilanes and chlorosilanes.

The proposed method of synthesis of fluorocarbofunctional alkoxysilanes and chlorosilanes of the general formula 1,

HCF₂(CF₂)ₙ(CH₂)ₘOC₃H₇SiR¹R²R³ (1)

in which:
n takes values from 1 to 12, m takes values from 1 to 4,
R¹ stands for an alkoxy group or halogen,
R² and R³ can be the same or different and
if R¹ stands for an alkoxy group, then R² and R³ stand for an alkoxy group containing C=1-4, an alkyl group containing C=1-12 or an aryl group,
if R¹ stands for a halogen, then R² and R³ can be the same or different stand for a halogen, an alkyl group containing C=1-12 or an aryl group,
   based on hydrosilylation of an appropriate fluoroalkyl-allyl ether of the general formula 2,

HCF₂(CF₂)ₙ(CH₂)ₘOCH₂CH═CH₂ (2)

in which n and m take the same values as specified above,
with a proper trisubstituted silane or chlorosilane of the general formula 3,

HSiR¹R²R³ (3)

in which
if R¹ stands for a halogen, then R² and R³ can be the same or different and stand for a halogen, alkyl group containing C=1-12 or an aryl group,
if R¹ stands for an alkoxy group, then R² and R³ can be the same or different and stand for an alkoxy group containing C=1-4, an alkyl group containing C=1-12 or an aryl group,
   in the presence of siloxide rhodium complex [{Rh(OSiMe₃)(cod)}₂] as a catalyst. The reaction is conducted at temperatures from the range 25-60° C., until the reaction completion, which usually takes 0.5 to 2 hours, in an open system and under atmospheric pressure.

It is recommended but not necessary to use allyl-fluoroalkyl ether in excess with respect to the appropriate silane or chlorosilane to ensure complete consumption of silane as its remains weaken the stability of the product. The most beneficial is the excess in the amount of close to 1.1 or from the range of 1.1-1.4.

The catalyst is used in the amount of 10⁻⁴ to 10⁻⁶ mol Rh per 1 mol of silane or chlorosilane; the best results are obtained with the catalyst in the amount of 5×10⁻⁵ mol per 1 mol of silane or chlorosilane.

In the method of synthesis which is the subject of this invention, an appropriate allyl-fluoroalkyl ether and the catalyst [{Rh(OSiMe₃)(cod)}₂] are introduced into the reactor in the amounts corresponding to the concentrations corresponding to 10⁻⁴ do 10⁻⁶ mol of Rh per 1 mol of Si—H groups. The substrates are stirred to get a homogenous system to which an appropriate silane is introduced in doses. After introduction of the whole load of silane, the content of the reactor is stirred on heating to a temperature from the range 25-60° C. at which the reactor is kept till the reaction completion, which usually takes from 1 to 4 hours. The product can be directly used in many applications, but when it must be of high purity the post-reaction mixture is subjected to fractional distillation to remove the remains of unreacted substrates and the catalyst.

The method of synthesis which is the subject of this invention permits obtaining fluorocarbofunctional alkoxysilanes or chlorosilanes in a single stage process.

The use of siloxide rhodium complex as a catalyst in the hydrosilylation of ethers in the method proposed permitted a decrease in the temperature of the process and significant shortening of the process, which prevents from the occurrence of many side reactions (e.g. isomerization of fluoroalkyl-allyl ether) improving the yield and selectivity of the process. In contrast to the hitherto applied platinum catalysts, the rhodium catalysts show greater resistance to poisoning and are less sensitive to the impurities contained in the substrates. Moreover, the rhodium catalysts permit a single-stage synthesis of a variety of fluoroalkyl alkoxysilane or chlorosilane derivatives with no need of modification of the method for particular groups of derivatives. Fluoroalkyl-allyl ether used in the synthesis proposed is obtained by the known Williamson method from fluorinated alcohols being much easier accessible and cheaper than fluoroalkyl iodides used in other known methods.

The synthesis which is the subject of this invention is illustrated by the following examples that do not limit the scope of its application.

### EXAMPLE I

Portions of 20.4 g (75 mmol) of allyl-octafluoropentyl ether and 0.22 μg (10⁻⁵ mol Rh/l mol Si—H) of siloxide rhodium complex [{Rh(OSiMe₃)(cod)}₂] were placed in a flask equipped with a magnetic stirrer, reflux and dropping funnel protected against moisture. Then upon stirring of the flask content, 11.5 g (70 mmol) of HSi(OEt)₃ were added dropwise. After introduction of the whole load of silane, the content was stirred for 1 hour at 60° C. Then the mixture was subjected to distillation under reduced pressure and the fraction boiling at 108-110° C./2 mmHg was collected. The final product of (octafluoropentyloxypropyl)triethoxysilane was obtained in the amount of 29.9 g, which makes 98% of the theoretical yield. The identity of the product was confirmed by NMR analysis.

¹H NMR (C₆D₆, 298 K, 300 MHz) δ (ppm): 0.6 (2H, —SiCH₂—); 1.13 (9H, CH₃—); 1.67 (2H, —CH₂—); 3.17 (2H, —CH₂O—); 3.47 (2H, —OCH₂—CF₂—); 3.72 (6H, CH₃—CH₂O—); 5.59 (1H, —CF₂H)

¹³C NMR (C₆D₆, 298 K, 75.5 MHz) δ (ppm): 6.73 (—SiCH₂—); 18.38 (—CH₃); 23.34 (—CH₂—); 58.47 (—OCH₂CH₃); 67.52 (—OCH₂CF₂—); 75.03 (—CH₂O—); 108.17, 111.53, 116.00 (—CF₂—); 119.39 (—CF₂H)

²⁹Si NMR (C₆D₆, 298 K, 59.6 MHz) δ (ppm): −46.14 ((EtO)₃SiCH₂—)

### EXAMPLE II

Portions of 12.9 g (75 mmol) of allyl-tetrafluoropropyl ether and 0.22 μg mol Rh/l mol Si—H) of siloxide rhodium complex [{Rh(OSiMe₃)(cod)}₂] were placed in a flask equipped with a magnetic stirrer, reflux and dropping funnel protected against moisture. Upon stirring of the flask content, 11.5 g (70 mmol) of HSi(OEt)₃ were added dropwise. After introduction of the whole load of silane, the content was stirred for 2 h at 25° C. Then the mixture was subjected to distillation under reduced pressure, collecting the fraction boiling at 84-87° C./2 mmHg. The final product of (tetrafluoropropyloxypropyl)triethoxysilane was obtained in the amount of 21.2 g, which makes 92% of the theoretical yield. The identity of the product was confirmed by NMR analysis.

¹H NMR (C₆D₆, 298 K, 300 MHz) δ (ppm): 0.57 (2H, —SiCH₂—); 1.15 (9H, CH₃—); 1.64 (2H, —CH₂—); 3.10 (2H, —CH₂O—); 3.37 (2H, —OCH₂CF₂—); 3.78 (6H, CH₃CH₂O—); 5.59 (1H, —CF₂H)

¹³C NMR (C₆D₆, 298 K, 75.5 MHz) δ (ppm): 6.77 (—SiCH₂—); 18.43 (—CH₃); 23.27 (—CH₂CH₂CH₂—); 58.48 (—OCH₂CH₃); 67.97 (—OCH₂—); 74.60 (—CH₂CH₂O—); 109.58 (—CF₂—); 115.37 (—CF₂H)

²⁹Si NMR (C₆D₆, 298 K, 59.6 MHz) δ (ppm): −46.18 ((EtO)₃SiCH₂—)

### EXAMPLE III

Synthesis was conducted as in example I, but the difference was the introduction of 13.7 g (70 mmol) of diethoxyphenylsilane instead of triethoxysilane. The process was conducted at 60° C. for 2 hours and the mixture obtained was subjected to distillation, and the fraction boiling at 147-150° C./2 mmHg was collected. The product was (octafluoropentyloxypropyl)diethoxyphenylsilane obtained in the amount of 30.7 g, which makes 94% of the theoretical yield. The identity of the product was confirmed by NMR analysis.

¹H NMR (C₆D₆, 298 K, 300 MHz) δ (ppm): 0.54 (2H, —SiCH₂—); 1.18 (6H, CH₃—); 1.67 (2H, —CH₂—); 3.28 (2H, —CH₂O—); 3.59 (2H, —OCH₂—CF2—); 3.69 (4H, CH₃—CH₂O—); 5.95 (1H, —CF₂H), 7.46-7.58 (3H, Ph), 7.81 (2H, Ph)

### EXAMPLE IV

Synthesis was conducted as in example II, but the difference was the introduction of 7.3 g (70 mmol) of dimethylethoxysilane instead of triethoxysilane. The process was conducted at 40° C. for 2 hours. Then the mixture obtained was subjected to distillation and the fraction boiling at 75-79° C./5 mmHg was collected. The final product of 18.1 g (tetrafluoropropyloxypropyl)dimethyloethoxysilane was obtained in the amount of 18.1 g, which makes 94% of the theoretical yield. The identity of the product was confirmed by NMR analysis.

¹H NMR (C₆D₆, 298 K, 300 MHz) δ (ppm): 0.07 (6H, SiCH₃); 0.65 (2H, —SiCH₂—); 1.17 (3H, CH₃—); 1.59 (2H, —CH₂—); 3.18 (2H, —CH₂O—); 3.45 (2H, —OCH₂CF₂—); 3.89 (2H, CH₃CH₂O—); 5.91 (1H, —CF₂H)

### EXAMPLE V

Portions of 12.9 g (75 mmol) of allyl-tetra-fluoropropyl ether and 0.11 mg (5×10⁻⁵ mol Rh/l mol Si—H) of siloxide rhodium complex [{Rh(OSiMe₃)(cod)}₂] were introduced into a flask equipped with a magnetic stirrer, reflux and dropping funnel protected against moisture. Upon stirring of the flask content, 9.5 g (70 mmol) of HSiCl₃ was added dropwise and the content was stirred for 1 hour at room temperature. The mixture obtained was subjected to distillation under reduced pressure and the fraction boiling at 53-55° C./3 mmHg was collected. Distillation was performed in the apparatus protected against the access of moisture. The final product of (tetrafluoropropoxypropyl)trichlorosilane was obtained in the amount of 20.5 g, which makes 89% of the theoretical yield.

### EXAMPLE VI

Portions of 20.4 g (75 mmol) of allyl-octafluoropentyl ether and 0.11 mg (5×10⁻⁵ mol Rh/l mol Si—H) of siloxide rhodium complex [{Rh(OSiMe₃)(cod)}₂] were placed in a flask equipped with a magnetic stirrer, reflux and dropping funnel protected against access of moisture. Upon stirring of the flask content, 8.1 g (70 mmol) of HSiMeCl₂ was added dropwise and then the content was stirred for 1 hour at room temperature. The mixture obtained was subjected to distillation under reduced pressure and the fraction boiling at 102-105° C./3 mmHg was collected. The product of (octafluoropentyloxypropyl)-methyldichlorosilane was obtained in 23.8 g, which makes 88% of the theoretical yield.

### EXAMPLE VII

Portions of 27.9 g (75 mmol) of allyl-dodecafluoroheptyl ether and 0.11 mg (5×10⁻⁵ mol Rh/l mol Si—H) of siloxide rhodium complex [{Rh(OSiMe₃)(cod)}₂] were placed in a flask equipped with a magnetic stirrer, reflux and dropping funnel protected against access of moisture. Then upon stirring of the content of the flask, 12.4 g (70 mmol) of HSiPhCl₂ were added. After introduction of the whole load of silane, the content was stirred for 2 h at 40° C. Then, the mixture obtained was subjected to distillation under reduced pressure and the fraction boiling at 146-149° C./5 mmHg was collected. He final product of (dodecafluoroheptyloxypropyl)dichlorophenylsilane was obtained in the amount of 31.5 g, which makes 82% of the theoretical yield.

### LIST OF REFERENCES

1. B. Marciniec, H. Maciejewski, C. Pietraszuk, P. Pawlua, Hydrosilylation. A Comprehensive Review on Recent Advances, Springer, 2009
2. M. A. Brook, Silicon in Organic, Organometallic and Polymer Chemistry, Wiley, New York, 2000

1. The method of synthesis of fluorocarbofunctional alkoxysilanes and chlorosilanes of the general formula 1,
HCF₂(CF₂)ₙ(CH₂)ₘOC₃H₇SiR¹R²R³ (1)
in which
n takes values from 1 to 12, m takes values from 1 to 4,
R¹ stands for an alkoxy group or halogen,
R² and R³ can be the same or different and stand for:
if R¹ stands for an alkoxy group, then R² and R³ can be the same or different and stand for an alkoxy group containing C=1-4, alkyl group containing C=1-12 or an aryl group,
if R¹ stands for a halogen, then R² and R³ can be the same or different and stand for a halogen, alkyl group containing C=1-12 or an aryl group,
based on hydrosilylation of an appropriate fluoroalkyl-allyl ether of the general formula 2,
HCF₂(CF₂)ₙ(CH₂)ₘOCH₂CH═CH₂ (2)
in which n and m take the values specified above, with an appropriate trisubstituted silane of the general formula 3,
HSiR¹R²R³ (3)
in which R¹, R² and R³ have the meaning specified above, in the presence of siloxide rhodium complex [{Rh(OSiMe₃)(cod)}₂] as a catalyst.

2. The method of synthesis as in claim 1 wherein the catalyst is used in the amount from the range 10⁻⁴ to 10⁻⁶ mol Rh per 1 mol silane.

3. The method of synthesis as in claim 2 wherein the catalyst is used in the amount of 5×10⁻⁵ mol Rh per 1 mol silane.
